(19) United States
(12) Patent Application Publication
(10) Pub. No.: US 2018/0057338 A1
(43) Pub. Date: Mar. 1, 2018

(54) Drink Producing Apparatus With A Decompression Chamber Chargeable With Ambient Air, Household Refrigeration Apparatus As Well As Method For Producing A Drink

(71) Applicant: BSH HAUSGERAETE GMBH, MUENCHEN (DE)

(72) Inventors: KUDRET BAYSAL, GIENGEN BRENZ (DE); CARSTEN WEISS, GIENGEN (DE)

(21) Appl. No.: 15/252,566

(22) Filed: Aug. 31, 2016

(51) Int. Cl. B67D 1/00; A23L 2/54; B01F 3/04; B01F 15/02; F25D 23/12

(52) U.S. Cl. CPC B67D 1/0058; A23L 2/54; B01F 3/04808; B01F 15/0243; B01F 15/026; B01F 2003/049; B67D 1/0078; F25D 23/12; A23V 2002/00; B01F 2003/04872; B67D 1/0015

(57) ABSTRACT

The invention relates to a drink producing apparatus with a dispensing container, which is formed for receiving a first liquid addable to a drink by the drink producing apparatus and which is connected to a dispensing unit of the drink producing apparatus for conducting the liquid from the dispensing container to the dispensing unit, wherein a decompression chamber is formed between the dispensing container and the dispensing unit, in which the carbonized liquid can be expanded to a pressure lower compared to a pressure present before introduction into the decompression chamber, and the drink producing apparatus has an air supply unit, by which ambient air can be conveyed into the decompression chamber for generating the pressure in the decompression chamber. The invention also relates to a household refrigeration apparatus and a method.

### TECHNICAL FIELD

The invention relates to a drink producing apparatus with a first dispensing container, which is formed for receiving a first liquid addable to a drink by the drink producing apparatus. The dispensing container is connected to a dispensing unit of the drink producing apparatus for conducting the first liquid from the first dispensing container to the dispensing unit. Furthermore, the invention also relates to a household refrigeration apparatus as well as to a method for producing a drink by a drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which has a drink apparatus, which is formed for dispensing a drink at this household refrigeration apparatus itself.

Moreover, cold drink machines are also known, in which alcohol containing drinks, for example cocktails, can be dispensed.

In such drink producing apparatuses for producing cooled drinks, tempering is an essential factor.

Moreover, drink producing apparatuses for household refrigeration apparatuses are known, which are formed for dispensing cooled drinks and in which a carbonizing gas such as carbon dioxide is addable to a liquid of the drink. Therein, it is known that a liquid is stored in a corresponding container in highly carbonized manner. The dispensing of the carbonized liquid then results in undesired splashing upon dispensing at the dispensing unit since the pressure is relatively high.

### BRIEF SUMMARY OF THE INVENTION

It is the object of the present invention to provide a drink producing apparatus as well as a household refrigeration apparatus as well as a method for producing a drink, by which or in which the production of a carbonized liquid for a drink is improved

This object is solved by a drink producing apparatus, a household refrigeration apparatus and a method according to the independent claims.

A drink producing apparatus according to the invention for a household refrigeration apparatus includes a dispensing container, which is formed for receiving a liquid addable to a drink by the drink producing apparatus. The dispensing container is connected to a dispensing unit of the drink producing apparatus for conducting the liquid from the dispensing container to the dispensing unit. An essential idea of the invention is to be regarded in that a decompression chamber is formed on the dispensing path between the dispensing container and a dispensing unit, which can then have a dispensing opening, in which the carbonized first liquid can be expanded to a pressure lower compared to a pressure before introduction into the decompression chamber. The drink producing apparatus moreover includes an air supply unit, by which ambient air can be conveyed into the decompression chamber for generating the pressure or decompression pressure in the decompression chamber.

Especially in carbonized liquids, which are thus introduced in the dispensing container in a state mixed with carbon dioxide, a pressure level of this liquid is usually prevalent there, which is too high for dispensing at the dispensing unit and thus at the dispensing opening. Undesired splashing or bubbling of the dispensed jet occurs and results in the fact that flow into a receiving vessel placed in a recess is insufficiently effected. In particular, a dispensing opening of the dispensing unit disposed at a ceiling wall bounding the recess then also dispenses this jet such that the recess is undesirably and relatively severely splashed. By the invention, this carbonized liquid is reduced from its higher pressure prevailing in the dispensing container to a lower pressure before dispensing via the dispensing opening. In that it is not introduced another special gas such as for example carbon dioxide into the decompression chamber by the present air supply unit, but conventional ambient air present in the ambient, undesired loss of carbon dioxide is also avoided. This could arise if upon expansion in the decompression chamber the carbon dioxide then remaining is discharged. Since the decompression chamber is in particular adapted to the amount of liquid maximally required for the preparation of the drink, in such a configuration, in particular if smaller drink amounts are required, very much carbon dioxide would then still be lost, in particular discharged from the decompression chamber via an exterior valve. By the supply of the ambient air, therefore, this aspect either is no longer relevant.

In particular, it is provided that a check valve is disposed between the air supply unit and the decompression chamber. Thereby, a sufficient amount of ambient air can be conveyed into the decompression chamber and undesired leakage flow from the decompression chamber via the air supply unit to the outside can be prevented.

In particular, it is provided that the air supply unit is an air pump. Such a configuration is functionally very simply constructed and still reliable and robust in operating principle and functional principle. Moreover, an air pump can also be attached in very space saving and compact manner.

Preferably, it is provided that the low pressure in the decompression chamber is between 2 bar and 2.5 bar. Such a pressure level is advantageous to the effect that the carbonizing degree in the liquid is not undesirably lowered, the dispensing of the carbonized liquid via the dispensing unit does not cause undesirably severe splashing etc. on the other hand.

In particular, it is provided that a discharge line for discharging decompression gas from the decompression chamber is connected to the decompression chamber and a throttle valve is disposed in the discharge line. Thereby, this decompression gas, which is formed upon expansion of the carbonized liquid, can be delivered in much dosed manner.

In particular, it is provided that the dispensing unit has a dispensing opening, from which the drink can be dispensed.

In particular, the air supply unit is disposed such that ambient air blown out by it is directed towards a jet of the liquid dispensed from the first dispensing container and the air is directly addable to the jet before the dispensing opening such that the orientation of the jet is variable in defined manner before the dispensing opening by the air addition. Thereby, an arc extent of the jet to be dispensed can for example be varied in defined manner. This is in particular advantageous if the drink producing apparatus has a capsule in the first dispensing container, in which an addition medium is contained, which is addable to the dispensed liquid jet. In particular, in such a configuration, a defined point of meeting with the jet of the addition medium is then achieved by the orientation of the jet. This point of meeting is selected in defined manner such that it is above a placed receiving vessel in height position and thus mixing of the jet of the carbonized liquid exiting from the dispensing opening and the jet of the addition medium from the capsule is already extensively effected before arrival at the receiving vessel.

In particular, it is provided that the drink producing apparatus has a further second dispensing container to the first dispensing container, which is formed for receiving a second liquid addable to a drink by the drink producing apparatus. This second dispensing container too is connected to the dispensing unit of the drink producing apparatus for conducting the second liquid from the second dispensing container to the dispensing unit.

In particular, the two liquids are different in their freezing point, wherein one of the liquids can be water or contain water and the other liquid can be alcohol or contain alcohol.

Furthermore, the invention also relates to a household refrigeration apparatus for storing and preserving food, for example a refrigerator or a freezer or a combined refrigerator-freezer, which has a housing, in which a receiving space for food is formed. The household refrigeration apparatus includes a drink producing apparatus according to the invention or an advantageous configuration thereof.

Furthermore, the invention also relates to a method for producing and in particular also dispensing a drink by a drink producing apparatus. The drink producing apparatus is formed with a dispensing container, which is formed for receiving a liquid addable to a drink by the drink producing apparatus. This dispensing container is connected to a dispensing unit of the drink producing apparatus for conducting the liquid from the dispensing container to the dispensing unit. The essential idea is to be regarded in that the carbonized liquid is conducted into a decompression chamber disposed between the dispensing container and the dispensing unit, in which this carbonized liquid is expanded to a pressure lower compared to the pressure before introduction into the decompression chamber. For adjusting the lower pressure in the decompression chamber, ambient air of the drink producing apparatus is conveyed into the decompression chamber by an air supply unit of the drink producing apparatus. The advantages achievable thereby were already mentioned in the presentation of the drink producing apparatus.

In particular, a value between 2 bar and 2.5 bar is adjusted as the low pressure. In particular, a cooled drink can be produced and dispensed by the drink producing apparatus. In particular, it is provided that the at least one first dispensing container can be cooled by a cooling device of the drink producing apparatus. The cooling device can in particular be a refrigeration circuit having a condenser, a compressor and at least one evaporator, by which the dispensing container can be cooled. If multiple such dispensing containers are present, it is preferably provided that the refrigeration circuit has multiple evaporators such that each dispensing container can be cooled by an own evaporator.

During drink dispensing, various pressures exist in the decompression chamber 26. These pressures are in particular between 2 and 2.5 bar in order that the carbonized liquid gets from its dispensing container 24, 25, in which a pressure at ca. 4 bar exists, to the decompression chamber 26 in controlled manner and without too much degassing of carbon dioxide. Thereafter, the pressure is lowered to ambient pressure via the throttle valve 28 and then the carbonized liquid is dispensed. By the intermediate stage with the at least one decompression chamber 26, it is ensured that the carbonized liquid does not lose too much carbon dioxide until it reaches the receiving vessel, and it is achieved that the liquid jet is smoothly and uniformly dispensed at the dispensing unit on the other hand.

Advantageous implementations of the drink producing apparatus according to the invention are to be regarded as advantageous implementations of the method according to the invention, wherein the respective objective features of the drink producing apparatus are thereto formed for performing the method steps.

In addition, it can also be provided that the drink producing apparatus is formed for receiving a capsule, in which additives, which can be added to the drink. Additives can be powdery or gelatinous or also liquid. In this context, the capsule can then be inserted into a dispensing area of the drink producing apparatus and this ingredient of the capsule can then also be automatically dispensed or added or already be added upon dispensing the drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible and exposed on the front side and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing drinks can be simplified. An essential advantage of this configuration is to be regarded in that the accessibility to the housing of the drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention with an embodiment of a drink producing apparatus; and

FIG. 2 a schematic representation of components of the drink producing apparatus.

### PREFERRED EMBODIMENTS OF THE INVENTION

In the figures, identical or functionally identical elements are provided with the same reference characters.

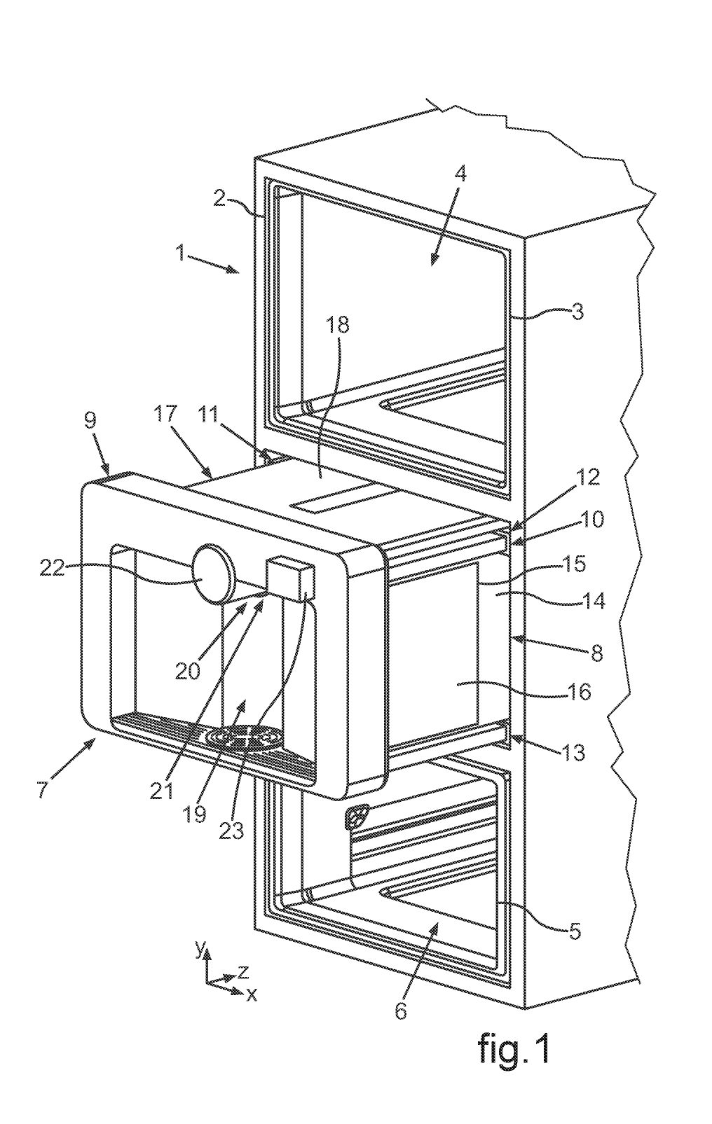

In FIG. 1, a household refrigeration apparatus 1 is illustrated in certain areas in a simplified perspective representation. Here, the household refrigeration apparatus 1 is for example a combined refrigerator-freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7.

However, the drink producing apparatus 7 can also be formed as a separate independent apparatus and thus be installed independently of a household refrigeration apparatus 1 and operable independently thereof.

The drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 has a housing 9.

In the embodiment, it is provided that the housing 9 and thus the entire drink producing apparatus 7 can be extracted from and again retracted into the receiving area 8 in depth direction and thus in horizontal direction corresponding to the z-direction corresponding to a drawer. In FIG. 1, the completely extracted state is shown.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also has an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 has a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead of it, a magnetic mount can also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead of it, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can be admixed to this drink to be produced, which can be produced and thus mixed from at least two different liquids. Thereto, it can in particular be provided that a capsule receptacle 22 is formed, into which a capsule having the mentioned additive can be inserted. Upon dispensing the drink, this ingredient or additive is then removed from the capsule and added to the drink in particular after dispensing into the drinking vessel effected via the dispensing opening 21.

Moreover, it can in particular be provided that the drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 has a cartridge for admixing carbon dioxide into the drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the drink as water does not have to be stored in a largely dimensioned container in the drink producing apparatus 7 but that this container can then be smaller dimensioned and can be refilled depending on demand and adapted to situation. It can then also be provided that such a water supply for producing the drink is not supplied from the tank or the container provided for receiving this liquid in the drink producing apparatus 7, but additionally or instead thereof can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the drink should then be desired, thus, this can be allowed via admixture of carbonized cold water, which is cooled in the drink producing apparatus 7, or via a carbonized second liquid, which is then present in the second container.

It is in particular provided that the drink producing apparatus 7 has a first container, in which a first liquid with a first freezing point, in particular water, is then provided or stored to then provide it for producing and dispensing a drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the drink can also be an alcoholized drink.

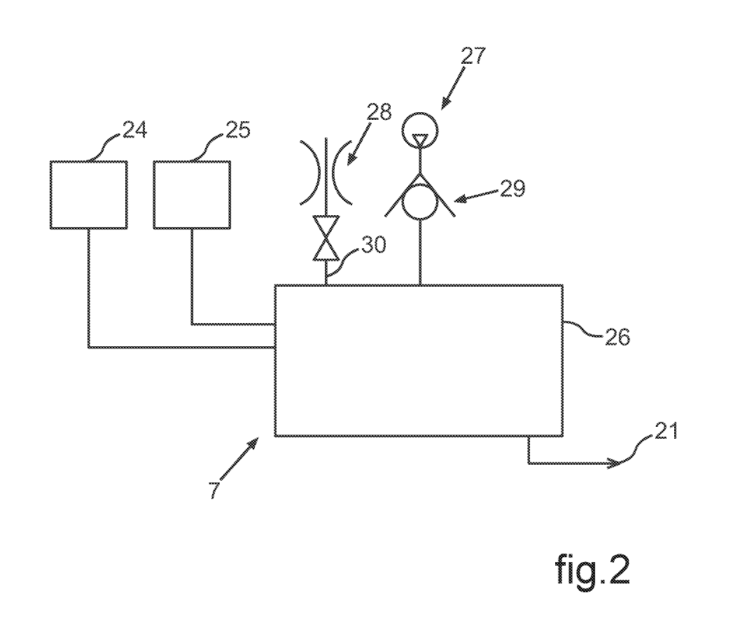

In FIG. 2, the drink producing apparatus 7 is shown with partial components in a schematic representation. It includes a first dispensing container 24, which is formed for receiving a first liquid, for example water. In particular, the drink producing apparatus 7 includes at least one second dispensing container 25, which is formed for receiving a second liquid, which is also addable to the drink to be dispensed, in the embodiment. In particular, the two liquids differ with respect to their freezing point. The second liquid can for example be alcohol or an alcohol containing liquid. Therefore, the drink producing apparatus 7 is a mixed drink producing apparatus in this example. In particular, it is provided that the first liquid in the first dispensing container 24 and/or the second liquid in the second dispensing container 25 are carbonized and thus mixed with carbon dioxide. In order to avoid an undesirably bubbling or splashing dispensing of this at least one carbonized liquid at the dispensing opening 21, it is provided that a decompression chamber 26 is disposed on the line path between a dispensing container 24 and/or 25 and the dispensing opening 21. It is formed to reduce the pressure level in the carbonized liquid before the dispensing opening 21. Preferably, it is provided that an own, separate decompression chamber is associated with each dispensing container 24 and 25, in particular if both liquids in the dispensing containers 24, 25 are carbonized.

In particular, it is provided that the drink producing apparatus 7 has an air supply unit 27, which is in particular an air pump. Ambient air is sucked in and passed into the decompression chamber 26 by the air supply unit 27. Thus, the decompression chamber 26 is brought to the desired intermediate pressure level with the ambient air by this air supply unit 27, which is preferably between 2 bar and 2.5 bar. Therein, relevant degassing of the liquid is avoided in the short periods of time for decompression and for dispensing the liquid, and carbon dioxide is barely lost to the environment upon venting the decompression chamber 26 via a throttle valve 28 disposed in a discharge line 30. Thus, the remaining decompression gas can then again be discharged from the decompression chamber 26 via the throttle valve 28 in defined manner. Slow pressure decrease is effected and thereby uniform and smooth dispensing of liquid is allowed. In particular, a check valve 29 is disposed between the air supply unit 27 and the decompression chamber 26.

Thus, it is achieved that decompression of a carbonized liquid at the higher pressure level, the first liquid if it is carbonized and/or the second liquid if it is carbonized, is effected in the decompression chamber 26 filled with ambient air.

During drink dispensing various pressures exist in the decompression chamber 26. These pressures are in particular between 2 and 2.5 bar in order that the carbonized liquid gets from its dispensing container 24, 25, in which a pressure at ca. 4 bar exists, to the decompression chamber 26 in controlled manner and without too much degassing of carbon dioxide. Thereafter, the pressure is lowered to ambient pressure via the throttle valve 28 and then the carbonized liquid is dispensed. By the intermediate stage with the at least one decompression chamber 26, it is ensured that the carbonized liquid does not lose too much carbon dioxide until it reaches the receiving vessel and it is achieved that the liquid jet is smoothly and uniformly dispensed at the dispensing unit on the other hand.

In particular, it is provided that the air supply unit 27 is employed in multi-functional manner and is also formed for manipulating an orientation of a jet, which is to be dispensed from the dispensing opening 21, besides conveying ambient air into the decompression chamber 26. Thereto, it is provided that the air supply unit 27 is disposed such that air blown out by it is directed towards a jet of the first liquid and/or the second liquid emanating from the decompression chamber 26 and this blown out air is directly addable to this jet before the dispensing opening 21 such that the orientation of the jet is variable in defined manner after the dispensing opening 21 and thus upon exit from the dispensing opening 21 by this air addition. In particular, this is advantageous if a capsule not shown is present and disposed in its addition position such that upon opening the capsule a jet of the addition medium located therein leaks out and then meets with the jet from the dispensing opening 21 in defined height position. This height position is in particular above a receiving vessel, which is then located in the placing bay 19 of the drink producing apparatus 7.

### LIST OF REFERENCE CHARACTERS

1 Household refrigeration apparatus
2 housing
3 interior container
4 first receiving space
5 interior container
6 second receiving space
7 drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 dispensing container
25 dispensing container
26 decompression chamber
27 air supply unit
28 throttle valve
29 check valve
30 discharge line

1. A drink producing apparatus, comprising:
a dispensing unit for dispensing liquid from the drink producing apparatus,
a dispensing container, which is formed for receiving a first liquid addable to a drink by the drink producing apparatus, wherein
the dispensing container is connected to the dispensing unit of the drink producing apparatus for conducting the liquid from the dispensing container to the dispensing unit, wherein
a decompression chamber, which is formed between the die dispensing container and the dispensing unit and in which the carbonized liquid can be expanded to a pressure lower compared to a pressure before introduction into the decompression chamber, and
an air supply unit, by which ambient air can be conveyed into the decompression chamber for generating the pressure in the decompression chamber.

2. The drink producing apparatus according to claim 1, wherein a check valve is disposed between the air supply unit and the decompression chamber.

3. The drink producing apparatus according to claim 2, wherein the air supply unit is an air pump.

4. The drink producing apparatus according to claim 1, wherein the low pressure in the decompression chamber is between 2 bar and 2.5 bar.

5. The drink producing apparatus according to claim 1, wherein a discharge line for discharging decompression gas from the decompression chamber is connected to the decompression chamber, and a throttle valve is disposed in the discharge line.

6. The drink producing apparatus according to claim 1, wherein the dispensing unit has a dispensing opening, from which the drink can be dispensed, and the air supply unit is disposed such that air blown out by it is directed towards a jet of the liquid dispensed from the decompression chamber and the air is directly addable to the jet before the dispensing opening such that the orientation of the jet after the dispensing opening is variable by the air addition.

7. A household refrigeration apparatus with a housing, in which a receiving space for food is formed, and with a drink producing apparatus having:
a dispensing unit for dispensing liquid from the drink producing apparatus,
a dispensing container, which is formed for receiving a first liquid addable to a drink by the drink producing apparatus, wherein
the dispensing container is connected to the dispensing unit of the drink producing apparatus for conducting the liquid from the dispensing container to the dispensing unit, wherein
a decompression chamber, which is formed between the dispensing container and the dispensing unit and in which the carbonized liquid can be expanded to a pressure lower compared to a pressure present before introduction into the decompression chamber, and
an air supply unit, by which ambient air can be conveyed into the decompression chamber for generating the pressure in the decompression chamber.

8. A method for producing a drink by a drink producing apparatus having the following steps of:
providing a dispensing unit for dispensing liquid from the drink producing apparatus,
providing a dispensing container, which is formed for receiving a first liquid addable to a drink by the drink producing apparatus,
connecting the dispensing container to the dispensing unit for conducting the liquid from the dispensing container to the dispensing unit,
conducting the carbonized liquid into a decompression chamber disposed between the dispensing container and the dispensing unit,
expanding the carbonized liquid in the decompression chamber to a lower pressure compared to a pressure before introduction into the decompression chamber, wherein
for adjusting the lower pressure in the decompression chamber, ambient air of the drink producing apparatus is conveyed into the decompression chamber by an air supply unit of the drink producing apparatus.

9. The method according to claim 8, wherein a value between 2 bar and 2.5 bar is adjusted as the lower pressure.

10. The method according to claim 8, wherein the drink is dispensed from a dispensing opening of the dispensing unit and the air blown out by the air supply unit is directed towards a jet of the liquid dispensed from the dispensing container and the air is directly added to the jet before the dispensing opening such that the orientation of the jet after the dispensing opening is varied by the air addition.
